(19) United States
(12) Patent Application Publication
(10) Pub. No.: US 2007/0175677 A1
(43) Pub. Date: Aug. 2, 2007

(54) Mini container handling unit

(76) Inventor: Steve L. Jantzen, Jerseyville, IL (US)

Correspondence Address: Henry W. Cummings, 3313 W. Adams St., P.O. Box 297, St. Charles, MO, 63301, US

(21) Appl. No.: 11/524,795

(22) Filed: Sep. 21, 2006

Related U.S. Application Data
(60) Provisional application No. 60/763,194, filed on Jan. 30, 2006.

(51) Int. Cl. B62M 7/14

(52) U.S. Cl. 180/11

(57) ABSTRACT

A system is provided for the integration of freight transportation from the producers work site to the freight carrier, including any intermediate carriers using carriers adapted for carrying motor vehicles. The system of the invention allows a producer to load a module at the work site, move the module directly from the work site to a vehicle carrier for a return trip, which it would normally make empty, carrying general freight. The present system adapts vehicle carriers for carrying general freight by utilizing a portable module that is carried by the vehicle carrier in substantially the same way as a vehicle to carry general freight. The system of the invention is applicable both to rail vehicle carriers and ships especially adapted for carrying vehicles as well as to over-the-road vehicle carriers. The base of the module is substantially the same length and width as the motor vehicles normally transported by the vehicle carrier and it is provided with at least one set of wheels for portability and for allowing of the module to be loaded onto a vehicle carrier by moving the module onto the carrier with a suitable tractor.

This application is a continuation of Application Ser. No. 60/763,194 filed Jan. 30, 2006.

### BACKGROUND OF THE INVENTION

The cost of handling automobiles is high largely due to the fact that car handling equipment is designed to Haul cars only. After the auto is delivered, the car hauling equipment returns to the plant empty, and the Total round trip must be charged to cars hauled one way. U.S. Pat. No. 6,599,082, incorporated herein by this reference, describes a method and apparatus of utilizing over the road railroad car automobile carriers For carrying a small container in the automobiles' stead for the return trip.

The present invention provides an improved method and apparatus which eliminates some of the Problems of the prior art.

### SUMMARY OF THE INVENTION

The present invention comprises a container handling unit having at least a pair of retractable wheels a, A powered steering axle b, attached to a moment beam c, and having an operator compartment d, and a power supply and transmission equipment e. The fixed axle wheels are retained on one end, and a powered steering axle is added to the other end. The powered steering axle is detachable and constitutes The power motive unit. Thus the container-vehicle will behave like cars and trucks that are presently Handled on car haulers.

### THE DRAWINGS

FIG. 1 is a perspective view of a mini-container motive handling unit which may be used in the invention.

FIG. 2 is a side elevation view of the handling unit shown in FIG. 1 approaching a container.

FIG. 3 is a side elevation view of the handling unit shown in FIG. 1 attached to the container.

FIG. 4 is a side elevation view of the handling unit shown in FIG. 3 with balance wheels retracted and The unit ready to move.

FIG. 5 is a perspective view of an embodiment of the mini-container handling unit of the present Invention.

### DESCRIPTION OF PREFERRED EMBODIMENTS

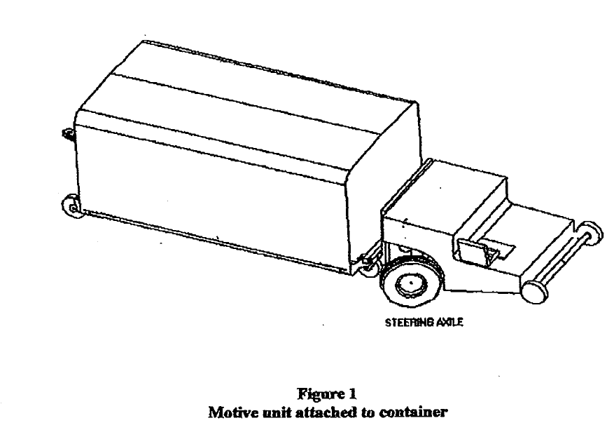

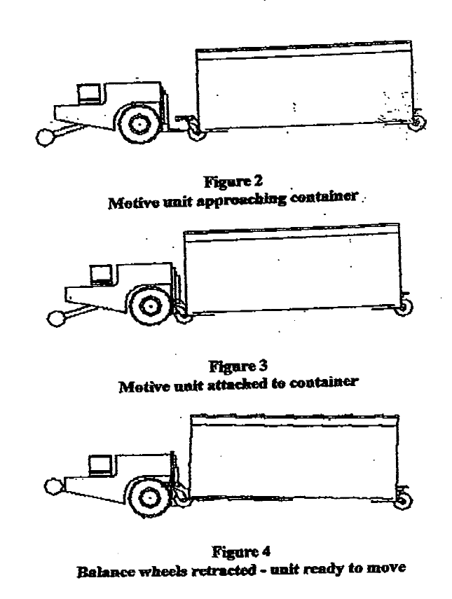

FIG. 1 shows the motive unit attached to a container.

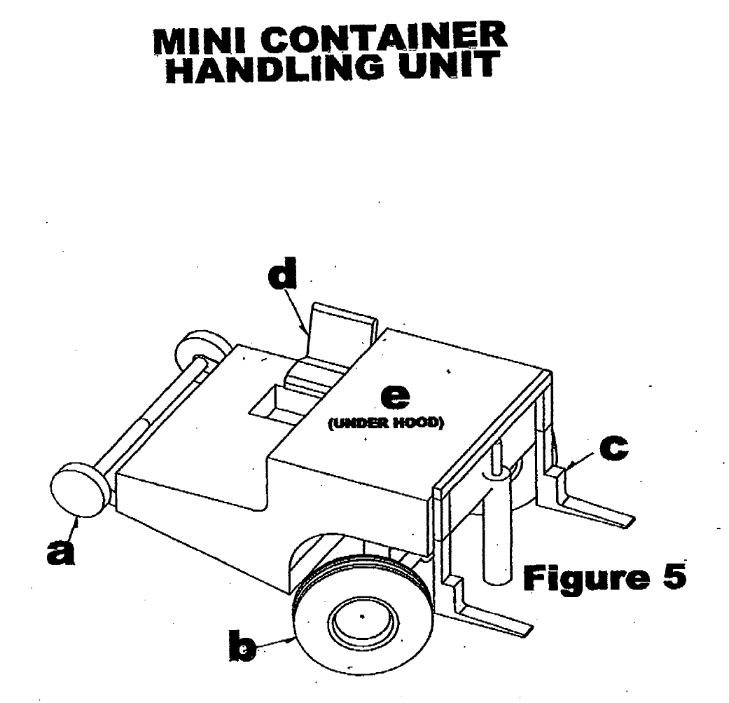

Referring to FIG. 5, retractable balance wheels allow the motive unit to travel while unattached to a Container. These wheels should not contact the ground while the motive unit is moving a container, Because there would be three non-articulating axles on the ground, and would make the combined motive Unit and container unsteerable. Furthermore, these wheels must retract enough to accommodate the abrupt changes in grade while maintaining ground clearance.

Powered axle b becomes the second axle of the container when the motive unit then has all the functional Characteristics of a four wheel vehicle, with two steerable, powered wheels, with brakes, and a drivers Compartment.

Attachment apparatus c, affixes the motive unit to the container, and restrains it to about five degrees of Freedom, including translation about all three axis, with rotation about the lateral and vertical axis. Rotation about the longitudinal axis may be unrestrained to accommodate non-plain surface. Rotation About the lateral axis is of particular importance. There needs to be the capacity to take a couple about This axis to account for the offset between the point of sheer transfer, a vertical force, to the wheel center. This differentiates the motive unit from a fork truck. The vertical load can be anywhere on the fork Surface due to the fork truck's counterweight. The motive unit has no counterweight.

In the operators compartment d, the operator or driver sits sideways to facilitate travel in both directions. Controls are similar to those in a fork truck, including a steering wheel, a foot operated accelerator and brake, and hand operated gear changing, and hydraulic functions.

The power supply and power transmission equipment e includes a power source such as an engine or electric motor to supply power to the steering axle and the auxiliary hydraulic functions. Enough Horsepower is required to supply power to negotiate a vertical surface at a minimum acceptable speed. The power transmission equipment must transmit enough torque to the wheel to allow negotiation of the steepest grade.

What is claimed is:

1. A container handling unit comprising:
A container supporting body portion having support means for engaging and supporting a container;
At least one pair of retractable wheels at a first end of said body portion; and
At least one powered steering axle having a second pair of wheels longitudinally spaced from said Retractable wheels.

2. A container handling unit according to claim 1 wherein said container supporting body is located above said steering axle.

3. A container handling unit according to claim 2 wherein said wheels do not contact the ground While said unit is moving a container.

4. A container handling unit according to claim 3 wherein said wheels retract sufficiently to accommodate abrupt and gradual changes in grade while maintaining ground clearance.

5. A container handling unit according to claim 4 wherein said power steering axle becomes The second axle of said container when a motive unit is affixed to said power steering axle.
